(19) United States
(12) Patent Application Publication
(10) Pub. No.: US 2024/0371590 A1
(43) Pub. Date: Nov. 7, 2024

(54) SWITCH ASSEMBLY FOR POWER TOOLS

(71) Applicant: TECHTRONIC CORDLESS GP, Anderson, SC (US)

(72) Inventor: Joseph Manuel Suarez, Anderson, SC (US)

(21) Appl. No.: 18/647,049

(22) Filed: Apr. 26, 2024

Related U.S. Application Data
(60) Provisional application No. 63/499,600, filed on May 2, 2023.

(51) Int. Cl. H01H 85/02; B25F 5/00

(52) U.S. Cl. CPC H01H 85/0241; B25F 5/00; H01H 2231/048

(57) ABSTRACT

A switch assembly for use in a power tool may include a load circuit having a movable contact through which an electrical current flows to operate the power tool. A switch assembly may include a biasing element configured to bias the movable contact toward an open position in the load circuit. A switch assembly may include a fuse element which, in an intact state, is configured to maintain the movable contact in a closed position in the load circuit against a bias of the biasing element, and which, in a broken state, is configured to permit the movable contact to move to the open position under the bias of the biasing element.

### CROSS-REFERENCE TO RELATED REFERENCES

This application claims priority to U.S. Provisional Patent Application No. 63/499,600 filed on May 2, 2023, the entire content of which is incorporated herein by reference.

### FIELD OF THE DISCLOSURE

The present disclosure relates to power tools, and more particularly, to switch assemblies used in power tools.

### BACKGROUND OF THE DISCLOSURE

Power tools may be used to perform work on a workpiece. Such power tools typically include switch assemblies operable to selectively provide electrical current from a power source, either remote or onboard (e.g., a battery pack), to an electric motor. Depending on the work performed by the power tool, it is desirable that the switch assembly quickly deactivate the electric motor in response to a user-actuated trigger being released.

### SUMMARY OF THE DISCLOSURE

In some aspects, the techniques described herein relate to a switch assembly for use in a power tool, the switch assembly including: a load circuit including a movable contact through which an electrical current flows to operate the power tool; a biasing element configured to bias the movable contact toward an open position in the load circuit; and a fuse element which, in an intact state, is configured to maintain the movable contact in a closed position in the load circuit against a bias of the biasing element, and which, in a broken state, is configured to permit the movable contact to move to the open position under the bias of the biasing element.

In some aspects, the techniques described herein relate to a switch assembly for use in a power tool, the switch assembly including: a load circuit including a movable contact through which an electrical current flows to operate the power tool; and a fuse element which, in an intact state, maintains the movable contact in a closed position in the load circuit, and which, in a broken state, permits the movable contact to move to an open position.

In some aspects, the techniques described herein relate to a power tool including: an electronic control unit configured to control operation of the power tool; and a switch assembly including a load circuit including a movable contact through which an electrical current flows to operate the power tool; and a fuse element which, in an intact state, maintains the movable contact in a closed position in the load circuit, and which, in a broken state, permits the movable contact to move to an open position, wherein when the electronic control unit detects a fault with the power tool, the fuse element is configured to break in response to an electrical current being passed through the fuse element.

In some aspects, the techniques described herein relate to a method of deactivating a power tool when a fault with the power tool occurs, the method including: detecting, by an electronic control unit, the fault with the power tool; passing an electrical current through a fuse circuit; and breaking a fuse element of a fuse circuit in response to the electrical current being passed through the fuse circuit to permit a movable contact of a load circuit to move from a closed position, in which an electrical current flowing through the load circuit operates the power tool, to an open position, in which the electrical current cannot flow through the load circuit and the power tool cannot operate.

Other aspects of the disclosure will become apparent by consideration of the detailed description and accompanying drawings.

### BRIEF DESCRIPTION OF THE DRAWINGS

FIG. 1 illustrates a perspective view of a power tool.

FIG. 2 illustrates a schematic view of a switch assembly in a closed state, for use with the power tool of FIG. 1.

FIG. 3 illustrates a schematic view of the switch assembly of FIG. 2 in an open state.

FIG. 4 illustrates a schematic view of a switch assembly in a closed state according to an embodiment of the disclosure, for use with the power tool of FIG. 1.

FIG. 5 illustrates a schematic view of the switch assembly of FIG. 4 in an open state.

FIG. 6 illustrates a schematic view of a switch assembly in a closed state according to an embodiment of the disclosure, for use with the power tool of FIG. 1.

FIG. 7 illustrates a schematic view of the switch assembly of FIG. 6 in an open state.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

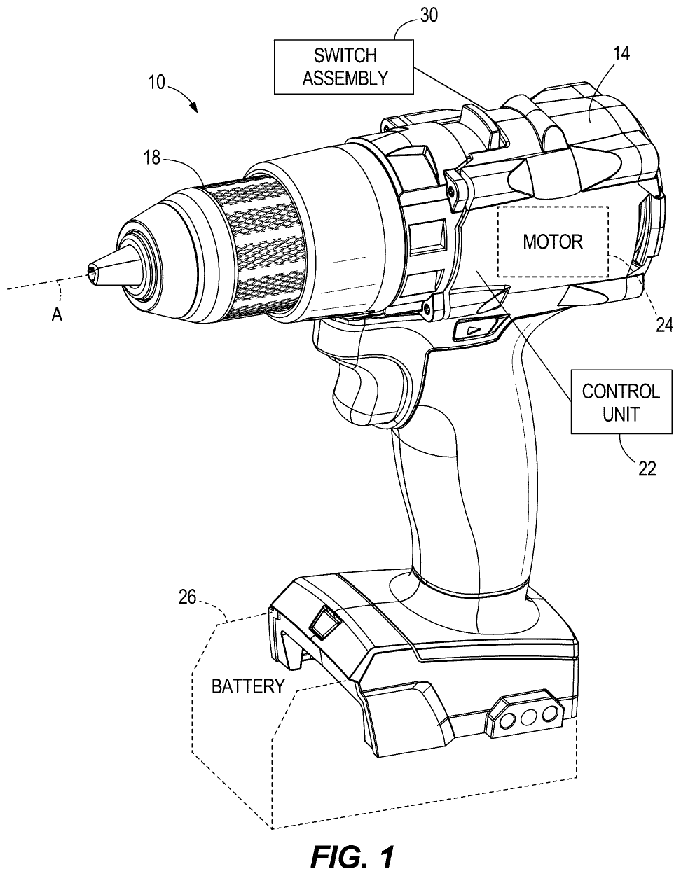

FIG. 1 illustrates a power tool 10 (e.g., drill or hammer drill). The power tool 10 includes a housing 14 and a chuck 18. A tool bit (not shown) is secured to the chuck 18 for co-rotation with the chuck 18 about a rotational axis A. The tool bit is configured to perform work on a workpiece. In other embodiments, the power tool 10 can be a fastener driver operable to drive fasteners (e.g., nails, tacks, staples, etc.) into the workpiece.

With continued reference to FIG. 1, the power tool 10 includes an electronic control unit 22 configured to control operation of the power tool 10. In some embodiments, the control unit 22 may include a PCB and switching electronics, such as MOSFETs, IGBTs, or the like, for providing power distribution and control to the power tool 10, and in particular an electric motor 24 (e.g., a brushless direct-current (BLDC) electric motor 24). The control unit 22 is disposed in the housing 14 of the power tool 10. The control unit 22 is further configured to detect a fault in the power tool 10 (e.g., misfiring of the power tool, loose tool bits, loose nails, etc.). The power tool 10 and the control unit 22 are powered by a power source such as a battery pack 26. In some embodiments, the battery pack 26 is onboard the power tool 10. In other embodiments, the battery pack 26 is separate from the power tool 10, or in yet other embodiments, the power tool 10 may receive electrical current from a remote power source (via an electrical cord).

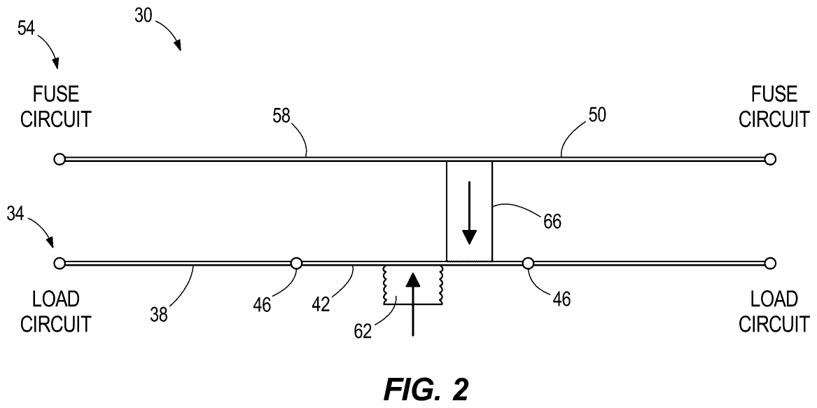

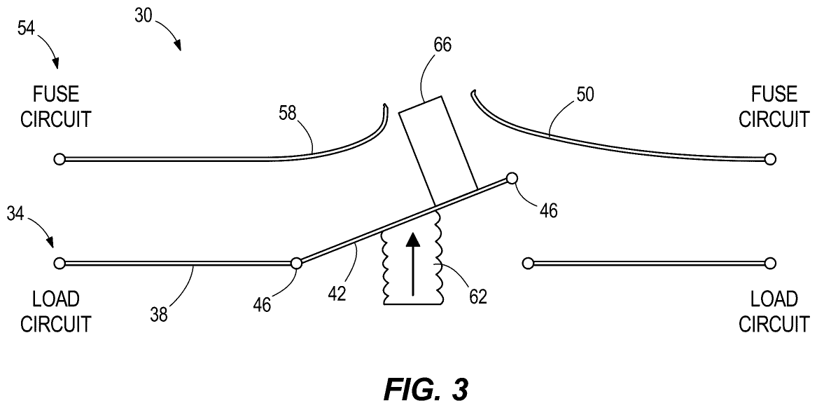

FIGS. 2 and 3 illustrate a switch assembly 30 for use with the power tool 10. The switch assembly 30 is onboard the power tool 10. The switch assembly 30 includes a load circuit 34 through which an electrical current flows to operate the power tool 10. The load circuit 34 includes a load circuit wire 38 and a movable contact 42 between load terminals 46. The movable contact 42 is movable between an open position and a closed position coinciding with an open state and a closed state, respectively, of the switch assembly 30. The power tool 10 is operational when the load terminals 46 of the movable contact 42 are in line with the load circuit wire 38 (i.e., the closed position). The power tool 10 is not operational when the movable contact 42 is open or the load terminals 46 are not in line with the load circuit wire 38 (i.e., the open position).

FIG. 2 illustrates a fuse element 50 positioned proximate the movable contact 42 of the load circuit 34. The fuse element 50 is a fragile or frangible element of the switch assembly 30. In some embodiments, the fuse element 50 is electrically wired to a fuse circuit 54. In some embodiments, the fuse element 50 is a small gauge electrical wire 58 that is electrically connected with the electronic control unit 22. In other embodiments, the fuse element 50 is an electrical printed trace on a printed circuit board or a rigid plate. For example, the electrical wire 58 comprising the fuse element 50 may include a gauge value less than or equal to 30. The fuse element 50, in an intact state, is configured to maintain the movable contact 42 in the closed position in the load circuit 34. And, the fuse element 50, in a broken state, is configured to permit the movable contact 42 to move to the open position in the load circuit 34.

With continued reference to FIG. 2, the fuse element 50 is configured to maintain the movable contact 42 in the closed position in the load circuit 34 against the force of a biasing element 62. In the illustrated embodiment, the biasing element 62 is a spring. In other embodiments, the biasing element 62 can be a lever, a system capable of storing potential energy, or other suitable mechanical systems or elements. The biasing element 62 is configured to bias the movable contact 42 toward the open position in the load circuit 34 when tension in the fuse circuit 54, and the fuse element 50 in particular, is released (e.g., when the fuse element 50 is broken). In some embodiments, the switch assembly 30 does not include the biasing element 62 such that the movable contact 42 is biased toward the open position in the load circuit 34 when tension in the fuse circuit 54, and the fuse element 50 in particular, is released (e.g., when the fuse element 50 is broken).

FIGS. 2 and 3 further illustrate a separator 66 positioned between the fuse element 50 and the movable contact 42 of the load circuit 34. The separator 66 and the fuse element 50, when in the intact state, together maintain the movable contact 42 of the load circuit 34 in the closed position. The separator 66 is made from an electrically insulating material. In some embodiments, the separator 66 can be an electrically insulated block.

As shown in FIG. 2, the switch assembly 30 is in an operational or closed state to operate the power tool 10. In the operational state, the fuse element 50 which, in an intact state, maintains the movable contact 42 in a closed position in the load circuit 34 against the bias of the biasing element 62. The separator 66 is positioned between the intact fuse element 50 and the movable contact 42 of the load circuit 34. The separator 66 further maintains the movable contact 42 in the closed position in the load circuit 34. The electrical current flows through the load circuit 34 to operate the power tool 10 and, because the separator 66 is made from a non-electrically conductive material, the electrical current through the load circuit 34 will not short to the fuse circuit 54.

As shown in FIG. 3, the switch assembly 30 is in a triggered or open state to deactivate the power tool 10. The triggered state is activated when the control unit 22 detects a fault with the power tool 10. In the triggered state, the fuse element 50 breaks in response to an electrical current being passed through the fuse circuit 54. The fuse element 50, in a broken state, permits the movable contact 42 to move to the open position in the load circuit 34 under the bias of the biasing element 62. In the broken state, the fuse element 50 and the separator 66 no longer maintain the movable contact 42 in the closed position in the load circuit 34. The biasing element 62 rebounds and moves the movable contact 42 toward the open position in the load circuit 34 when the fuse element 50 breaks, opening the load circuit 34 (in which, in some embodiments, the electric motor 24 is wired). As such, the electrical current no longer flows through the load circuit 34, thereby deactivating the power tool 10. Once the fuse element 50 is broken, the power tool 10 is quickly deactivated, thereby protecting the operator from a detected fault of the power tool 10.

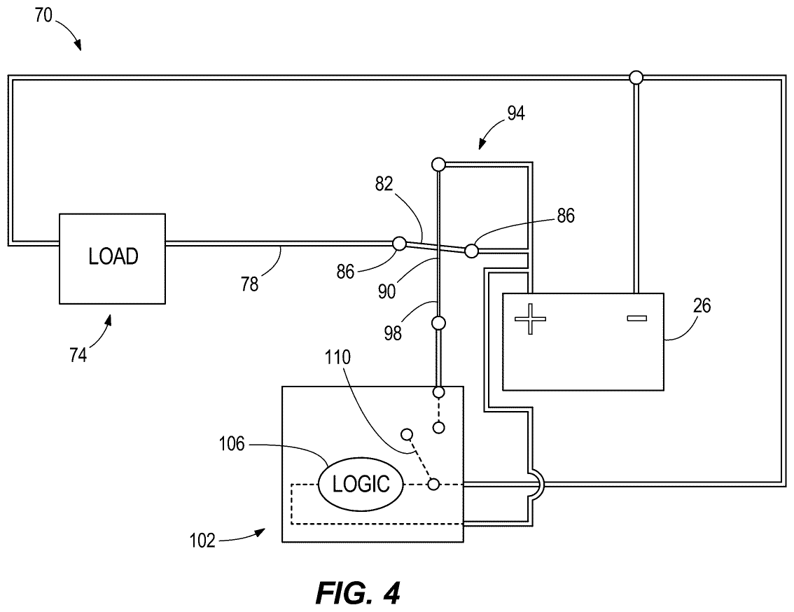

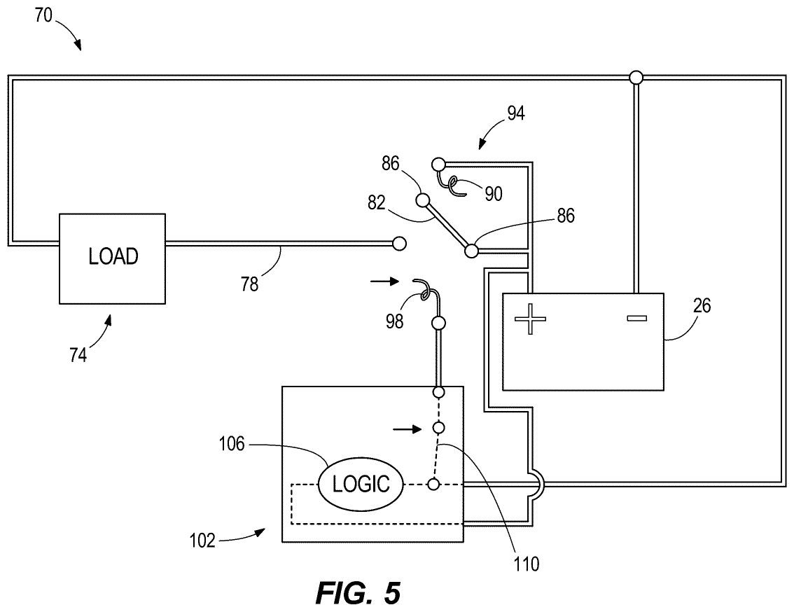

FIGS. 4 and 5 illustrate another embodiment of a switch assembly 70 for use with the power tool 10. The switch assembly 70 is onboard the power tool 10. The switch assembly 70 includes a load circuit 74 through which an electrical current flows to operate the power tool 10. The load circuit 74 includes a load circuit wire 78 and a movable contact 82 between load terminals 86. The movable contact 82 is movable between an open position and a closed position coinciding with an open state and a closed state, respectively, of the switch assembly 70. The power tool 10 is operational when the load terminals 86 of the movable contact 82 are in line with the load circuit wire 78 (i.e., the closed position). The power tool 10 is not operational when the movable contact 82 is open or the load terminals 86 are not in line with the load circuit wire 78 (i.e., the open position).

FIG. 4 illustrates a fuse element 90 in contact with the movable contact 82 of the load circuit 74. The fuse element 90 is a fragile or frangible element of the switch assembly 70. In some embodiments, the fuse element 90 is electrically wired to a fuse circuit 94. In some embodiments, the fuse element 90 is a small gauge electrical wire 98 that is electrically connected with the electronic control unit 22. In other embodiments, the fuse element 90 is an electrical printed trace on a printed circuit board or a rigid plate. For example, the electrical wire 98 comprising the fuse element 90 may include a gauge value less than or equal to 30. The fuse element 90, in an intact state (i.e., the tension in the fuse element 90 is preserved), maintains the movable contact 82 in the closed position in the load circuit 74. And, the fuse element 90, in a broken state (e.g., tension in the fuse element 90 is released), permits the movable contact 82 to move to the open position in the load circuit 74. The movable contact 82 is biased toward the open position in the load circuit 74 when the tension in the fuse element 90 is released.

With further reference to FIG. 4, in some embodiments, the fuse circuit 94, and in particular the fuse element 90, is electrically wired to a logic circuit 102. In some embodiments, the logic circuit 102 includes a circuit board 106 and a logic movable contact 110. The circuit board 106 includes a microcontroller or microprocessor and is configured to provide operational control of the logic movable contact 110. The logic movable contact 110 is movable between an open position and a closed position coinciding with a closed state and an open state, respectively of the logic circuit 102 (and therefore the switch assembly 70). When the logic movable contact 110 is in the open position, an electrical current does not flow through the fuse circuit 94, and tension in the fuse element 90 is preserved (i.e., the fuse element 90 remains intact). When the logic movable contact 110 is in the closed position, an electrical current flows through the fuse circuit 94, and in particular the fuse element 90, to break the fuse element 90 and release the tension in the fuse element 90.

As shown in FIG. 4, the switch assembly 70 is in an operational or closed state to operate the power tool 10. In the operational state, the fuse element 90, in an intact state, maintains the movable contact 82 in a closed position in the load circuit 74. The logic movable contact 110 is in an open position to prevent current from flowing into the fuse circuit 94, and in particular, the fuse element 90. The fuse circuit 94 and the load circuit 74 are at the same potential; therefore, direct contact between the movable contact 82 and the fuse element 90 does not affect the operation of the load circuit 74.

As shown in FIG. 5, the switch assembly 70 is triggered to an open state to deactivate the power tool 10. The triggered state occurs when the control unit 22 detects a fault with the power tool 10. The logic circuit 102 is electrically connected to the control unit 22 and, in response to detection of the fault, is changed to the closed state shown in FIG. 5. When the logic circuit 102 is in the closed state, an electrical current flows through the logic circuit 102 and the fuse element 90. Since the fuse element 90 includes a low current-carrying capacity, the fuse element 90 breaks (e.g., melts) in response to the electrical current being passed through the fuse circuit 94. The fuse element 90, in a broken state, permits the movable contact 82 to move to the open position in the load circuit 74. In the broken state, the fuse element 90 no longer maintains the movable contact 82 in the closed position in the load circuit 74. The movable contact 82 moves toward the open position in the load circuit 74 when the fuse element 90 breaks, opening the load circuit 74 (in which, in some embodiments, the electric motor 24 is wired). As such, the electrical current no longer flows through the load circuit 74, thereby deactivating the power tool 10. Once the fuse element 90 is broken, the power tool 10 is quickly deactivated, thereby protecting the operator from a detected fault of the power tool 10.

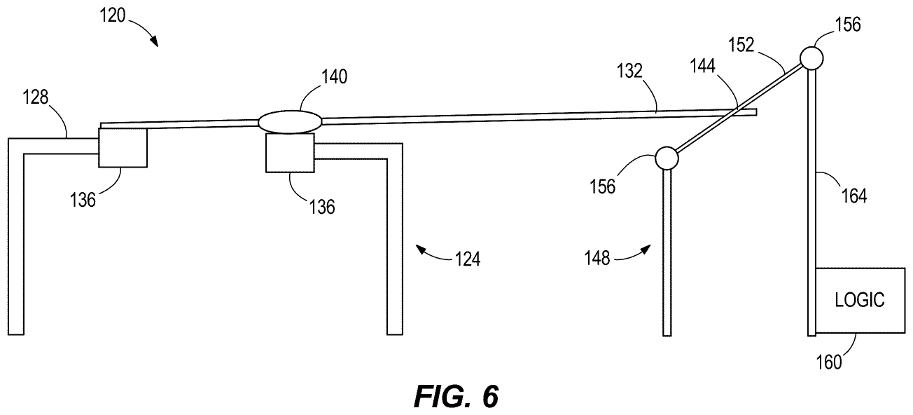

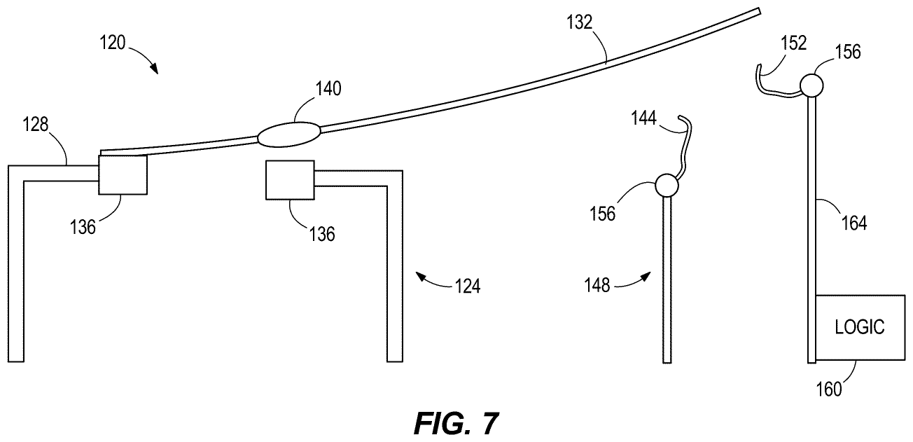

FIGS. 6 and 7 illustrate another embodiment of a switch assembly 120 for use with the power tool 10. The switch assembly 120 is onboard the power tool 10. The switch assembly 120 includes a load circuit 124 through which an electrical current flows to operate the power tool 10. In some embodiments, the electrical current flowing through the load circuit may be 50 Amperes, for example. The load circuit 124 includes a load circuit wire 128 and a movable contact 132 in contact with load terminals 136. The load circuit wire 128 may include a gauge value less than or equal to 10. In some embodiments, the movable contact 132 is a spring lever. An end of the movable contact 132 is in contact or fixed to one of the load terminals 136. The movable contact 132 further includes a contact plate 140 in contact with one of the load terminals 136. The movable contact 132 includes a length that extends beyond the load circuit 124 or the load terminals 136.

The movable contact 132 is movable between an open position and a closed position coinciding with an open state and a closed state, respectively, of the switch assembly 120. The power tool 10 is operational when the movable contact 132 is in contact, and in particular the contact plate 140, with the load terminals 136 (i.e., closed position). The power tool 10 is not operational when the movable contact 132 is open or the contact plate 140 is not in contact with the load terminals 136 (i.e., the open position).

FIG. 6 illustrates a fuse element 144 in contact with the movable contact 132 of the load circuit 124. The fuse element 144 is in contact with an end of the movable contact 132. In other embodiments, the fuse element 144 is in contact with the movable contact 132 at a point distal from the end of the movable contact 132. For example, positioning the fuse element 144 adjacent the end of the movable contact 132 allows for an increase in the mechanical advantage of the movable contact 132 (e.g., the movable contact 132 rebounds faster in response to a broken fuse element 144).

As shown in FIGS. 6 and 7, the fuse element 144 is a fragile or frangible element of the switch assembly 120. In some embodiments, the fuse element 144 is electrically wired to a fuse logic circuit 148. In some embodiments, the fuse element 144 is a small gauge electrical wire 152 that is electrically connected with the electronic control unit 22. In other embodiments, the fuse element 144 is an electrical printed trace on a printed circuit board or a rigid plate. For example, the electrical wire 152 comprising the fuse element 144 may include a gauge value less than or equal to 30. The fuse element 144, in an intact state (i.e., the tension in the fuse element 144 is preserved), maintains the movable contact 132 in the closed position in the load circuit 124. And, the fuse element 144, in a broken state (e.g., tension in the fuse element 144 is released), permits the movable contact 132 to move to the open position in the load circuit 124. The movable contact 132 is biased toward the open position such that when the tension in the fuse element 90 is released, the movable contact 132 moves to the open position in the load circuit 124.

With further reference to FIG. 6, the fuse element 144 is electrically wired to the fuse logic circuit 148 in between lug junctions 156. The lug junctions 156 (e.g., lugs) hold the fuse element 144 across the movable contact 132, and electrically connects the fuse element 144 to the fuse logic circuit 148. In some embodiments, the fuse logic circuit 148 includes a circuit board 160 having a microcontroller or microprocessor and is configured to provide operational control of the fuse logic circuit 148. The fuse logic circuit 148 may include a wire 164 with a gauge value less than or equal to 18. During normal operation of the power tool 10, an electrical current does not flow through the fuse logic circuit 148, and tension in the fuse element 144 is preserved (i.e., the fuse element 144 remains intact). When the power tool 10 detects a fault, an electrical current flows through the fuse logic circuit 148, and in particular the fuse element 144, to break the fuse element 144 and release the tension in the fuse element 144. In one example, the fuse logic circuit 148 may accommodate an electrical current of 20 Amperes and the electrical current necessary to break the fuse element 144 is 10 Amperes.

As shown in FIG. 6, the switch assembly 120 is in an operational or closed state to operate the power tool 10. In the operational state, the fuse element 144, in an intact state, maintains the movable contact 132 in a closed position in the load circuit 124. An electrical current flows through the load circuit 124 to operate the power tool 10. An electrical current does not flow through the fuse logic circuit 148, and tension in the fuse element 144 is preserved (i.e., the fuse element 144 remains intact). The fuse circuit 94 and the load circuit 74 are at the same potential; therefore, direct contact between the movable contact 132 and the fuse element 144 does not affect the operation of the load circuit 124.

As shown in FIG. 7, the switch assembly 120 is triggered to an open state to deactivate the power tool 10. The triggered state occurs when the control unit 22 detects a fault with the power tool 10. The fuse logic circuit 148 is electrically connected to the control unit 22 and, in response to detection of the fault, applies an electrical current through the fuse logic circuit 148, and in particular the fuse element 144. Since the fuse element 144 includes a low current-carrying capacity, the fuse element 144 breaks (e.g., melts) in response to the electrical current being passed through the fuse logic circuit 148. The fuse element 144, in a broken state, permits the movable contact 132 to move to the open position in the load circuit 74. In the broken state, the fuse element 144 no longer maintains the movable contact 132 in the closed position in the load circuit 124. The movable contact 132 moves toward the open position in the load circuit 124 when the fuse element 144 breaks, opening the load circuit 124 (in which, in some embodiments, the electric motor 24 is wired). As such, the electrical current no longer flows through the load circuit 124, thereby deactivating the power tool 10. Once the fuse element 144 is broken, the power tool 10 is quickly deactivated, thereby protecting the operator from a detected fault of the power tool 10.

Although the disclosure has been described in detail with reference to certain preferred embodiments, variations and modifications exist within the scope and spirit of one or more independent aspects of the disclosure as described.

While the disclosure has been presented with respect to a limited number of embodiments, those skilled in the art, having benefit of this disclosure, will appreciate that other embodiments may be devised which do not depart from the scope of the present disclosure. Accordingly, the scope of the disclosure should be limited only by the attached claims.

Various features of the disclosure are set forth in the following claims.

1. A switch assembly for use in a power tool, the switch assembly comprising:
a load circuit including a movable contact through which an electrical current flows to operate the power tool;
a biasing element configured to bias the movable contact toward an open position in the load circuit; and
a fuse element which, in an intact state, is configured to maintain the movable contact in a closed position in the load circuit against a bias of the biasing element, and which, in a broken state, is configured to permit the movable contact to move to the open position under the bias of the biasing element.

2. The switch assembly of claim 1, further comprising a fuse circuit in which the fuse element is electrically wired, wherein the fuse element is proximate the movable contact in the load circuit.

3. The switch assembly of claim 2, wherein the fuse element is configured as an electrical wire having a gauge value less than or equal to 30.

4. The switch assembly of claim 3, wherein the fuse element is configured to break in response to an electrical current being passed through the fuse circuit.

5. The switch assembly of claim 1, further comprising a separator positioned between the fuse element, when in the intact state, and the movable contact to maintain the movable contact in the closed position.

6. The switch assembly of claim 5, wherein the separator is made from an electrically insulating material.

7. The switch assembly of claim 1, wherein the movable contact includes a first end with a first load terminal and a second end with a second load terminal, and wherein when the movable contact is in the closed position in the load circuit, the first load terminal and the second load terminal are in line with a load circuit wire, and when the movable contact is in the open position, at least one of the first load terminal and the second load terminal is not in line with the load circuit wire.

8. A switch assembly for use in a power tool, the switch assembly comprising:
a load circuit including a movable contact through which an electrical current flows to operate the power tool; and
a fuse element which, in an intact state, maintains the movable contact in a closed position in the load circuit, and which, in a broken state, permits the movable contact to move to an open position.

9. The switch assembly of claim 8, wherein the fuse element is an electrical wire which, in the intact state, preserves tension in the fuse element, and which, in the broken state, releases tension in the fuse element.

10. The switch assembly of claim 8, further comprising a fuse circuit in which the fuse element is electrically wired, wherein the fuse element is in contact with the movable contact in the load circuit to maintain the movable contact in the closed position.

11. The switch assembly of claim 10, further comprising a logic circuit electrically wired to the fuse circuit, wherein the logic circuit includes a circuit board and a logic movable contact, wherein an electrical current does not pass through the fuse circuit when the logic movable contact is in an open position, and wherein an electrical current is passed through the fuse circuit when the logic movable contact is in a closed position.

12. The switch assembly of claim 11, wherein the fuse element is configured to break in response to the electrical current being passed through the fuse circuit, releasing tension in the fuse element and permitting the movable contact to move to the open position.

13. The switch assembly of claim 8, wherein the movable contact includes a first end with a first load terminal and a second end with a second load terminal, and wherein when the movable contact is in the closed position in the load circuit, the first load terminal and the second load terminal are in line with a load circuit wire, and when the movable contact is in the open position, at least one of the first load terminal and the second load terminal is not in line with the load circuit wire.

14. The switch assembly of claim 8, wherein the movable contact is a spring lever having a first end coupled to a first load terminal of the load circuit and a second end opposite the first end, and wherein when the movable contact is in the closed position in the load circuit, the second end is in contact with the fuse element.

15. The switch assembly of claim 14, wherein the movable contact includes a contact plate positioned between the first end and the second end, the contact plate configured to contact a second load terminal when the movable contact is in the closed position in the load circuit and to not contact the second load terminal when the movable contact is in the open position.

16. A power tool comprising:
an electronic control unit configured to control operation of the power tool; and
a switch assembly including
a load circuit including a movable contact through which an electrical current flows to operate the power tool; and
a fuse element which, in an intact state, maintains the movable contact in a closed position in the load circuit, and which, in a broken state, permits the movable contact to move to an open position,
wherein when the electronic control unit detects a fault with the power tool, the fuse element is configured to break in response to an electrical current being passed through the fuse element.

17. The power tool of claim 16, further comprising:
a biasing element configured to bias the movable contact toward the open position in the load circuit, and
a fuse circuit in which the fuse element is electrically wired, wherein the fuse element is proximate the movable contact in the load circuit,
wherein the fuse element, in the intact state, is configured to maintain the movable contact in the closed position in the load circuit against a bias of the biasing element, and wherein the fuse element, in the broken state, is configured to permit the movable contact to move to the open position in response to a bias of the biasing element.

18. The power tool of claim 17, further comprising a separator positioned between the fuse element, when in the intact state, and the movable contact to maintain the movable contact in the closed position.

19. The power tool of claim 16, further comprising a fuse circuit in which the fuse element is electrically wired, wherein the fuse element is in contact with the movable contact in the load circuit to maintain the movable contact in the closed position.

20. The power tool of claim 19, further comprising a logic circuit electrically wired to the fuse circuit, wherein the logic circuit includes a circuit board and a logic movable contact, wherein an electrical current does not pass through the fuse circuit when the logic movable contact is in an open position, wherein an electrical current is passed through the fuse circuit when the logic movable contact is in a closed position, and wherein the fuse element is configured to break in response to the electrical current being passed through the fuse circuit, releasing tension in the fuse element and permitting the movable contact to move to the open position.

21.-25. (canceled)
